(19) United States
(12) Patent Application Publication
(10) Pub. No.: US 2011/0083084 A1
(43) Pub. Date: Apr. 7, 2011

(54) Method and device for employing editors to compoile data for competence functions

(76) Inventor: Hans-Diedrich Kreft, Dassendorf (DE)

(21) Appl. No.: 12/587,247

(22) Filed: Oct. 5, 2009

(51) Int. Cl. G06F 3/01

(52) U.S. Cl. 715/751; 715/781

(57) ABSTRACT

Methods and devices are described with which screen displays, screen contents and screen layouts, for instance, job searches, are all available to users of competence functions (competence profiles) depending on the occurrence of certain types of data in databases. By means of the methods and devices, such screen displays, screen contents and screen layouts of job searches can be generated in the form of competence functions (competence profiles) depending on the occurrence of certain types of data in databases. It is likewise described how suitable search profiles can be found with competence functions and how suitable competence profiles can be found with search profiles.

### TECHNICAL-COMMERCIAL FIELD

The invention relates to methods and devices for employing designations of competences, occupations, knowledge and skills of the kind often found in the data pool of all kinds of databases, in order to employ editors to compile data for competence functions.

### STATE OF THE ART

The documents DE 10129826 A1, PCT/EP 01/07777, DE 10349271, DE 10353898, PCT/BP 2004/011864, DE 10358958, PCT/EP 2004/014197, DE 10 2007 04902.2 as well as DE 10 2008 012187.8 (application dated Mar. 3, 2008), and also the book titled “Geld and Wissen” [Money and Knowledge] (published by Weissensee Verlag, Berlin, Germany, 2003, ISBN 3-899998-021-2) disclose bar diagrams that associate monetary values (also monetary streams as amounts of money per unit of time) with products, services or else human knowledge and skills. These documents show how mathematical methods can be employed to obtain characteristic values from the bar diagrams (also referred to as competence functions, competence spectra and competence profiles). It can also be seen how the data is stored in technical systems (devices) in different ways on the basis of their standardized formats, then transmitted and made recognizable to people using devices at different locations. The technical means used are those of the Internet. Browsers are utilized for screen displays, access to server contents and for linking purposes.

Task at hand:

It is the objective of the present invention to link designations and descriptions of data—about competences, knowledge, skills, occupation, designations, courses of study as well as job offers of the type often found on servers, in databases, libraries, public institutions such as the government employment office—with data that results from the utilization of competence functions of technical systems, where it can be continuously modified through actions of users, and the objective is also to display this data to people in a specific form on technical systems such as PCs.

### INDUSTRIAL APPLICABILITY

Competence functions enable companies, for instance, to find suitable employees; trainees can be informed about the value of individual competences and can then establish their educational goals accordingly. The compilation of data from job offers via the Internet allows PC users who have an Internet connection to gain access to this data in a uniform, comparable form for decision-making purposes.

In order to achieve the objective, editors for compiling data for competence functions are described [A1],
whereby a list proposal LV for the selection of data sources for competence data DQ is displayed to a user in a first editor image EB-A;
whereby a user can electronically select at least one data source DQ A;
and the DQ A is listed in another editor image EB-B with its data contents DI;
whereby the DI contains at least one competence name;
whereby the DI is to be taken over in the bar chart EB-C of a competence function KF by means of a mouse click;
in that this data is augmented by additional dynamic data of competence functions for purposes of providing a visual display;
whereby this dynamic data is present on servers and is continuously changed there through the use of competence functions by additional users;
whereby the users change the dynamic data through their use via the Internet.

The above-mentioned editors are aimed at a user's actions that are determined by prompts in an editor window. The term “editor” refers to what is generally known from the work on technical devices such as PCs. Accordingly, editors are screen layouts that are provided with symbols and buttons, and that appear, for example, in browser windows and that, by means of specific information and prompts, help the user to fulfill a given task. Other wording is, for instance, input mask, input window, user prompting, etc.

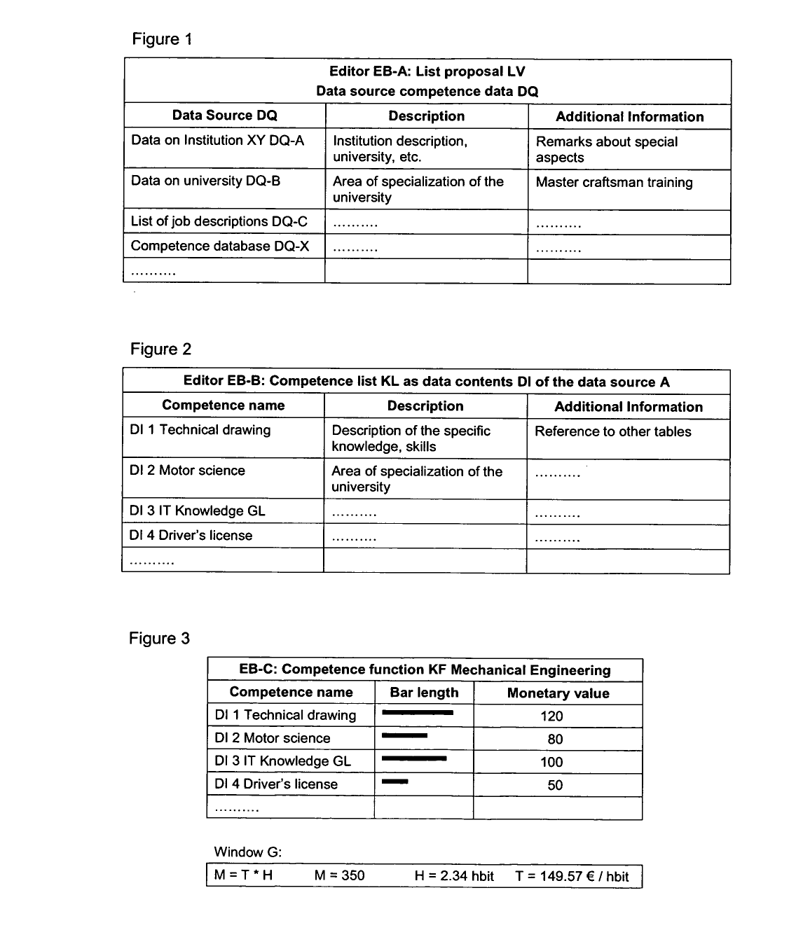

Three editor displays EB-A, EB-B and EB-C (see FIGS. 1, 2, 3) are used. EB-A shows a list proposal LV for selecting data sources for competence data DQ in a form that can be seen, for example, in FIG. 1. This is an overview of data sources DQ for descriptions of competences. Therefore, this is data that remains unchanged for a longer period of time since, for example, the description of the course of study “Mechanical Engineering” from the data source of a technical university does not change on a daily basis.

The user can, for instance, by means of an electronic mouse click (see Item A in FIG. 1), select a data source DQ A and can list its data contents DI in another editor image EB-B (FIG. 2). The data contains at least one competence name for each competence. The competence can be described by additional descriptions as a supplement to the competence name in such a way that what is meant by the term competence (the competence name) becomes clear. If a certain DI is selected, for example, by a mouse click, the data is taken over in the display of a competence function KF but, at this point in time, this competence function is still lacking additional data such as, for instance, the bar length or the monetary value. If additional data for the competence name is present on other servers, it can be supplemented and taken over in the display of the competence function. For instance, the data about bar length or monetary value is data that is present on the server and is continuously changing there through the use of the competence functions. Such continuously changing data is called dynamic data here. These instances of use take place in that competence functions under the compilation of a wide array of competence names (competence abbreviations) are present multiple times on computers (e.g. PCs, notebooks) of users and can be changed according to descriptions in the above-mentioned documents. The data exchange takes place via the Internet, whereby competence names (also referred to as competence abbreviations) are linked to an unambiguous alphanumeric value in a recognizable manner (as described in the above-mentioned documents). For example, if a user changes the bar length of a competence in his browser window, this is transmitted via the Internet to the server, where it influences the data (for instance, monetary value) that is present about this competence.

If no unambiguous alphanumeric identification for a competence name in a data source DQ is present yet, such an identification can be issued at the time of its first occurrence (for example, in accordance with the same algorithm as the one that was used for the existing name). Initial data can electively be employed for the missing dynamic data.

The DQ can be present on the same technical system as the one where one of the editor windows also appears. This can be, for example, the PC of a user. This can also be data pools that are present on remote computers such as servers, databases, etc. and that are accessible, for instance, via a remote connection (such as the Internet). The editor windows can be integrated into browser windows.

In another embodiment of the invention [A2], editors are described for compiling data for competence functions, whereby entire groups of DI are transferred from the DQ of the EB-A to the EB-C.

In claim 1 [A1], data contents (data records) for individual competences are transferred to the editor window EB-C. Claim 2 [A2] relates to the transfer of several competences that make up the occupation descriptions. Thus, a manager, for instance, has to be able to read balance sheets and have some understanding of detailed technical developments in mechanical engineering. Such compilations of competences (of competence groups) can already be present in the DQ since they serve there to define occupation descriptions or complex competence compilations. Such a competence group (group of data contents pertaining to competences) is transferred by a mouse click to a data source DQ and the individual competences are augmented accordingly with the data according to claim 1. For example, if the data source DQ-A of institution A is clicked on, all of the competences of the test subjects are transferred that are required, for instance, to earn a master's degree in mechanical engineering or in communication electronics. With the augmented data, a complete competence compilation appears in the form of a competence function for that job description.

In another embodiment of the invention [A3] according to claim 1, editors are described for compiling data for databases of competence functions,
whereby data contents DI pertaining to competences are entered in an editor window EB-B by a user at least with one competence name and description;
whereby this DI is transferred to databases in such a way that
it is available in an editor window EB-A so as to be transferred to competence functions according to EB-C.

In claims 1 and 2, data sources DQ are available for the use of competence data in competence functions, for example, in databases that are locally present on a PC or on remote computers. This data can be incomplete or outdated. Claim 3 [A3] indicates how new data contents DI pertaining to competences can be entered via an editor window EB-B. A user provides them with a competence name and a description. The data is transferred to databases via known transmission modalities and methods (as described, for example, in the above-mentioned documents). According to claim 1 or 2, the data can then be retrieved from the databases. In this manner, new competences can be made available on technical systems. It is practical for an instance to check the data for errors, lack of clarity or other circumstances before it is released for the claimed method. This way, it is ensured that the only data contained in databases (as sources of competence data) is data that meets certain conditions. The data thus entered can also be incorporated into a uniform numbering system using alphanumeric characters in order to prevent confusion or duplications.

In another embodiment of the invention [A4] according to claims 1 and 2, data about competence functions is displayed in a special way in editors,
1) in that data pertaining to a competence name is displayed in the editor window EB-C in another window G,
2) whereby this data is obtained from the data that is present on servers pertaining to the competence data in databases.

If, in accordance with claims 1 and 2, a user selects data about competences, then additional data pertaining to these competences such as monetary values, descriptions and statistical evaluations is present in databases. For instance, mean values of individual competences can be present, and formula values M, T, H for groups of competences as known from the book titled “Geld and Wissen” [Money and Knowledge] can also be present. In this manner, a great deal of data can be concurrently transferred and displayed in separate windows G. The description pertaining to a competence, for instance, its definition, can also be sent along and displayed. In a known manner, certain clicking fields in the editor window allow such data to also be displayed visually in many different ways.

Another objective is achieved according to the method through the interaction of technical devices in order to perform an automated compilation of competence profiles, and this is characterized in that [A5],
website addresses URI X are present in electronically stored form in a URI list in a technical system,
whereby a computer or server SA with an Internet connection uses the URI list in order to establish a connection to the computers URI-X,
whereby data DX is present on the computers URI-X and serves to search for personnel,
whereby the SA uses the establishment of a connection to the computer URI-X in order to transmit the data DX via the Internet to a storage unit MA in an electronic data processing system,
whereby another computer CG has programs and access possibilities on the MA for purposes of evaluating the data DX from the MA in such a way
as to yield a table for competence data DX,
so that the data of the DX can be displayed in the graphic form of a competence function.

This describes a method and the interaction of technical devices for the automated compilation of competence profiles [A5]. For this purpose, website addresses URI-X are present in electronically stored form in a URI list on a technical system. These are preferably website addresses of companies that have posted job openings on their servers, computers or electronic data processing systems. The website addresses URI-X, which are widely present, are used by a computer, an electronic data processing system or a server SA with an Internet connection in order to establish an Internet connection to the various computers URI-A, URI-X of companies that have data there pertaining to a search for personnel. This can be data that is publicly accessible to Web users in a generally known manner, and it can also be data that is only accessible via website addresses URI-X that are not public knowledge. Moreover, it is also possible to use any form of encryption of the stored data as well as of the transmitted data using conventional encryption algorithms and key releases between the computer SA and the URI-X. Once the connection between the SA and the URI-X has been established, the data DX is transmitted via the Internet to a storage unit MA of a computer of an electricity data processing system. This computer can be configured in the form of a SA or it can be separate from the SA. Another computer CG has specific programs, software and technical access possibilities to the data DX of the MA, so that a table for competence data DX can be generated on this basis. These specific programs of the CG can serve, for instance, to evaluate texts in the data DX. However, it can also be the case that special symbols in the DA have special meanings. Thus, for example, the value of a requested competence can be indicated by a euro symbol and can appear, for example, in the “value” column of the table with the competence data DX. The CG generates such data for the TKD which uses this to create the graphic form of a competence function, as has been described in the above-mentioned publications. Since this is a special form of a competence function that was generated on the basis of data pertaining to the search for personnel, it is also referred to here as a search profile or search function.

By means of Claim [A6], in accordance with Claim [A5],
in addition to the TKD, the original data DX is stored in a storage unit in such a way that
it is available either in the reduced form of the table pertaining to competence data DX or in the original form DX for electronic systems when the TKD is retrieved.

In Claim [A6], the original data DX, in the form in which it is also present on the URI-X, is stored in a storage unit in addition to the competence data table DX. In this manner, the data for the competence data table DX that was reduced by the software/programs of the CG as well as the original data are available for additional purposes of electronic data processing. The data DX can be retrieved when the data of the TKD is graphically displayed.

According to Claim [A7], the mode of operation of the computer CG in accordance with the method takes place in such a way that
data from a competence data template table TKV is used by the CG to generate the data of the TKD,
whereby unambiguous identifiers ID are associated with competence names in the TKV,
whereby software routines in the CG check whether competence names or identifiers ID are contained in the data of the DA,
whereby the competence names found are associated with an identifier ID or the identifier IDs found are associated with a competence name and transferred to the TKD,
by means of which the TKD can be augmented with additional data using the ID or the associated competence names from the table TKV.

The mode of operation of the CG, which searches among the data of the DX in order to find the data that is suitable for incorporation into the TKD, can be controlled by adding a prescribed competence data template table TKV. The TKV can contain competence names that are commonly used as abbreviations of competences in natural languages. Such a competence name is, for instance, the term “driver's license”. Additionally, a unique identifier ID in the form of an alphanumeric character can be associated with each competence name. Search algorithms in computers can be optimized with the ID. In addition, descriptions which provide a definition or explanation of the competence name can be present in the TKV pertaining to each competence name or ID. Moreover, additional data such as monetary values can be associated with the competence names. A wide array of additional information pertaining to the competences such as examinations (for instance, information about the driver's license test) or certifications (in the form of information about titles such as, for example, diplomas, etc.) are to be stored in the TKV. All of this data of the TKV can be used by the CG in order to analyze the data of the DX in such a way that identifier IDs or competence names can be obtained from the data DX. Once IDs or competence names have been determined in this manner, they can be transferred to the TKD which can be completed or augmented with additional data from the TKV or with data from other data pools on the basis of the fact that the IDs or the competence names are known. This method according to claim 2 ensures that any desired texts DX pertaining to job searches can be analyzed according to a scheme of the TKV and can then be displayed with their specific data in the uniform format of the TKD.

According to Claim [A8], the mode of operation of the computer CG in accordance with the method takes place in such a way that
1) the data from the competence data template table TKV also contains data resulting from statistical calculations or from methods or calculations of humatics,
2) whereby it is also possible to employ data from other sources that is present on local or decentralized electronic data processing systems.

From the above-mentioned elaborations, it is possible to see how certain novel data such as human potential, economic temperature and many other values, data and parameters pertaining to competence functions can be obtained. Such data can be present in the TKV and likewise be utilized during transfer to the TKD. There can also be statistical data pertaining to competences such as, for example, the frequency of their occurrence in certain geographic regions or their mean values, so that they can also be used by the CG. It is likewise possible for the data pertaining to competences or competence compilations (also competence functions) present on external (local or decentralized) electronic data processing systems to be incorporated into the TKV. This can be, for instance, salary data for certain occupation groups which was collected by certain organizations and can be employed to draw up search profiles, for example, in order to ascertain competence values.

According to Claim [A9], data is augmented in that data such as a company address, a contact person or a reference number is additionally entered into the TKD. For this purpose, FIG. 3 shows a specific search profile of a mechanical engineering company X with a reference number. The SA cannot obtain data such as the company address, the contact person, the reference number and the phone number from the data DX by making a comparison to the table TKV. This data can be ascertained additionally from company information that can be found, for example, via the URI list at the companies. This data can also be entered manually on a case-to-case basis, or else it can be obtained from lists that have been prepared for automatic queries. Subsequently, the data should be incorporated into the TKD.

According to Claim [A10], the mode of operation of the computer CG is such
1) that several synonymous competence names are present for one identifier ID of the TKV,
2) with which the CG transfers these synonymous competence names to the TKD.

It is a known procedure in natural languages to provide competences with synonymous names. If, for instance, the term “driver's license” is used, it is also possible to use “driving license”. If such synonymous competence names pertaining to an ID are stored in the TKV, these synonyms can be used during the analysis of the data of the DX. Therefore, the competence name (the competence designation) “driver's license” or, alternatively, “driving license” can appear in the DX; the same ID present in the TKV is associated by the CG and made available for use in the TKD. This synonymous use of competence names is indicated by the vertical double-headed arrow in FIG. 3 (search profile).

According to Claim [A11], the mode of operation of the computer CG is such
that several alternative competence names appear in the data DX,
whereby these alternative competence names are associated with different identifiers,
as a result of which alternative competence names with different IDs for one and the same table position are made available to the TKD by the CG.

It is a known procedure to allow alternative competences for one and the same position/task in an employment advertisement. For instance, a computer specialist, a programmer, a software specialist, a mathematician or a statistician, etc. are all possible candidates for the position “software quality testing”. All of these alternative competence designations (occupation designations) can appear in the DX with their different identifiers and can be present in the TKV. Once they are found by the CG, they can be transmitted to the TKD. Therefore, the TKD can contain alternative competence names as well as identifiers in one and the same table position (which can correspond to a storage unit location or a marking in a database). This alternativity is shown in FIG. 3 by a horizontal double-headed arrow in contrast to synonymity.

According to Claim [A12], automated search algorithms can be started via the Internet, so that
private browser users PBN such as commercial browser users KBN access data in electronic data processing storage systems I EDVI as well as in electronic data processing storage systems K EDVK via the Internet,
whereby competence functions of private or individual users are present in the EDVI,
whereby search functions of commercial users are present in the EDVK,
so that the data of the individual competence functions in the EDVI are used to find certain search functions in the EDVK,
or the data of the search functions in the EDVK is used to find certain competence functions in the EVDI.

The above-mentioned publications indicate how private, anonymous users of the Internet can set up competence functions by means of browsers on central computers and servers. These computers are designated as EDVI. The methods for compiling data for search profiles cited in the above-mentioned claims might be present on computers that are designated here as EDVK. Private Internet users PBN as well as commercial Internet users KBN having suitable technical systems (e.g. browsers or specific programs on PCs) can access both computers. Since the data is present in structured form as competence functions or search functions (competence profiles or search profiles) on both systems EDVI and EDVK, program routines controlled by software can perform alternating searches. In this manner, individual users can use the data of their competence profiles as a filter in order to search in the EDKV and can find such fitting search profiles. In a comparable way, commercial users can use their search profiles to find the suitable providers (users) of such competence profiles among the stock of individual competence profiles in the EDVI. Filter effects of the type described in the publication DE 10 2008 012 187.8 can be employed for the alternating search. For instance, when only one existing competence is prescribed in a competence function, a larger number of search profiles can be found than when several competences are prescribed. Moreover, the advantages of the above-mentioned synonymity of competence names or the alternativity of competence names can be in order to influence the results of the search. In the final analysis, the data in the EVDI can be used to search in the data in the EDVK and vice versa. The search in question can be controlled by users who have access to this data via the Internet.

According to Claim [A13], a technical system for carrying out the method is characterized in that,
via the Internet, the computer SA randomly generates addresses URI X according to an automatic algorithm,
whereby the systems, computers and storage units found with these addresses via the Internet are queried and checked for data of the type that is present in the TKV list,
so that a TKD is drawn up without a known URI list being prescribed.

The URI list serves as a prescribing list for querying websites, systems or storage units containing data about employment advertisements. It is also possible to draw up URI lists according to an automatic algorithm. The addresses generated in this manner can be processed in terms of the contents of employment advertisements in the same form as was described for the prescribed list, so that this ultimately once again results in the generation of a competence data table TKD.

The objective is also achieved by a device [A14] for the automated compilation of competence profiles like the technical device CG, especially the technical electronic data processing system, whereby
website addresses URI X are present in electronically stored form in a URI list on a technical system,
whereby a computer or server SA with an Internet connection uses the URI list in order to establish a connection to the computers URI X,
whereby data DX is present on the computers URI X and it serves to search for employees,
whereby the SA uses its connection to the computer URI X in order to transmit the data DX via the Internet to a storage unit MA in a electronic data processing system,
whereby another computer CG has programs and access possibilities on the MA for purposes of evaluating the data DX from the MA in such a way
that a table for competence data DX is created on this basis,
so that the data of the DX can be displayed in the graphic form of a competence function.

In another embodiment of the device according to the invention, said device is characterized in that [A15]
the data from a competence data template table TKV is used by the CG to generate the data of the TKD,
whereby unambiguous identifiers ID are associated with competence names in the TKV,
whereby software routines in the CG check whether competence names or identifiers ID are contained in the data of the DA,
whereby the found competence names are associated with an identifier ID or whether the found identifier IDs are associated with a competence name and transferred to the TKD,
by means of which the TKD can be augmented with additional data using the ID or the associated competence name from the table TKV.

Brief description of the drawing, which shows the following:

FIG. 1—a graphic depiction of an editor window EB-A in table form, with a list proposal LV from a data source for competence data DQ;

FIG. 2—symbolically, an “Editor EB-B” editor;

FIG. 3—symbolically, a competence function as the compilation of a group of competences;

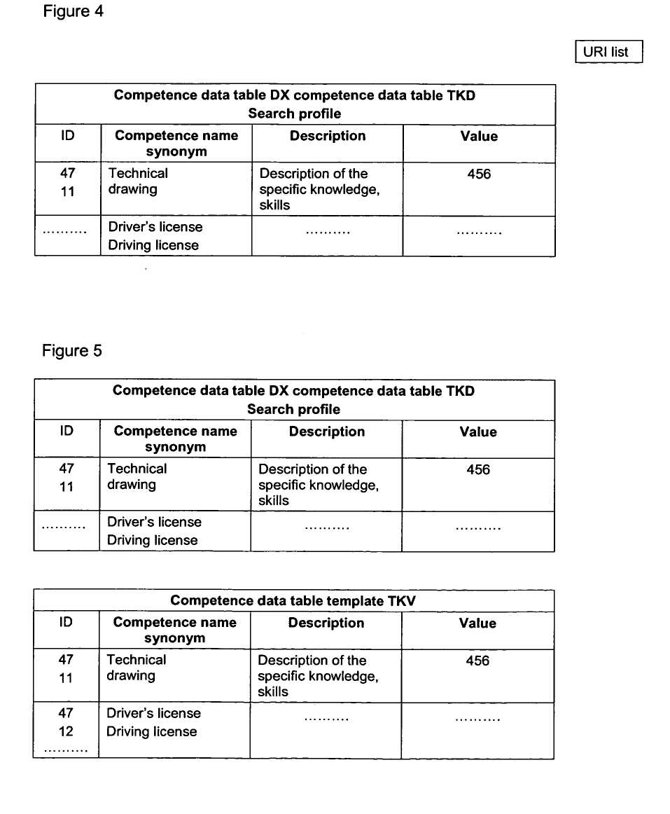

FIG. 4—symbolically, the principle of the automated creation of search profiles that are a certain form of competence profiles;

FIG. 5—symbolically, how the determination of identifiers and competence names can be controlled by the CG of a competence data template table TKV;

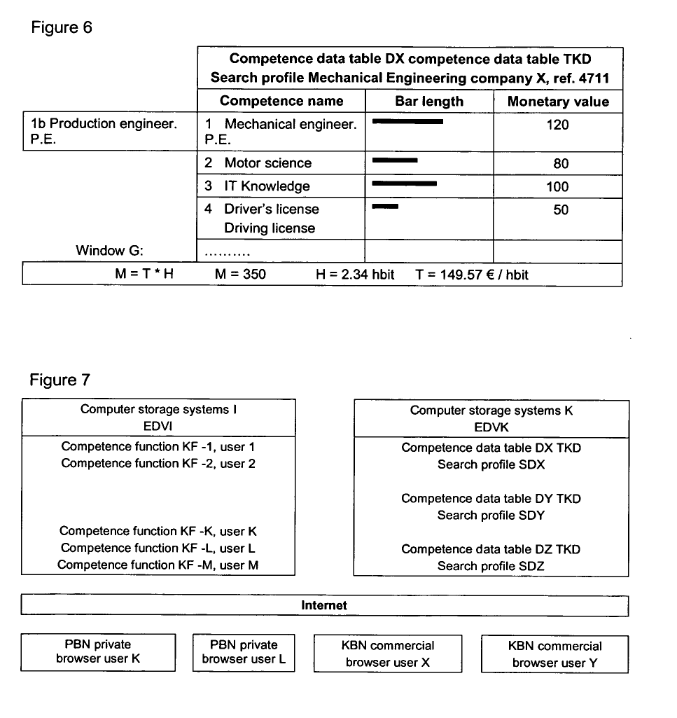

FIG. 6—symbolically, the result of a competence data compilation in the form of a competence function resulting from the data DX pertaining to a search for employees and

FIG. 7—symbolically, the alternating search between competence profiles that are present on electronic data processing storage systems I EDVI and search profiles that are present on electronic data processing storage systems K EDVK.

Ways to carry out the invention:

FIG. 1 shows a graphic depiction of an editor window EB-A in table form, with a list proposal LV from a data source for competence data DQ. The table is divided into three columns, namely, “Data Source DQ”, “Description” and “Additional Information”. The DQ column lists universities, institutions and databases (such as, for example, O*Net database of an American institution) from which competence data is available. Thus, for instance, data sources for studies and courses of training institutions such as colleges, etc. can be listed here. The “Description” column contains additional information about the data source. The “Additional Information” column can contain additional information such as date of generation, etc. Columns can be added for additional purposes.

The lines contain the individual data sources. For example, a data source is symbolically listed under the arrow marking A “Data on institution XY DQ-A”. Clicking on this line causes the data of this source to appear in a separate window (see the description pertaining to FIG. 2) and is available as such to be incorporated into the competence function.

FIG. 2 symbolically shows an “Editor EB-B: Competence list KL as data content DI of the data source A” editor that can be employed in a browser window to enter competence data into competence profiles. The “Competence name” column contains a short designation of a competence that is issued one single time, in other words, that designates exactly one competence. For instance, line three shows DI 3 IT knowledge GL, whereby the letter combination “GL” indicates, for example, basic knowledge. The “Description” column contains an explanatory or defining description pertaining to the competence name. The “Additional Information” column can indicate additional information such as occurrence in other tables, etc.

Under the designation “EB-C: Competence Profile KL Mechanical Engineering”, FIG. 3 symbolically shows a competence function as the compilation of a group of competences. The “Competence Name” column contains the abbreviation of the competence known from FIG. 2. The “Bar Length” column has a bar whose length is determined by the value in the “Monetary Value” column.

The lower section shows the formula M=T*H as is known in humatics science.

FIG. 4 symbolically shows the principle of the automated creation of search profiles that are a certain form of competence profiles (competence functions), making use of the Internet. Using a Web server SA, the appertaining websites are called via the Internet from a URI list of company website addresses. The pages URI A, URI X contain the company job offers that are preferably present as text data DA, DX for purposes of a more detailed description of the job offers in a wide array of formats. The data DA, DX is collected via the server SA by means of transmission by Internet and then stored on a storage unit MA. On the basis of this data, a computer CG with suitable software can then generate the kind of data necessary to build up a competence function (of a competence profile). This is data such as unambiguous identifiers ID pertaining to a competence name, competence name with synonyms, description of the competence, value of the competence as well as other data that is to be advantageously provided about competences or competence names. This data is stored in a competence data DX TKD table, and the original data DX can likewise be administered there. The TKD can then be accessed in such a way that a competence function can be displayed in a known manner, for example, on a PC monitor.

FIG. 5 symbolically shows how the determination of identifiers and competence names by the CG can be controlled by a competence data template table TKV. Many identifiers ID, competence names, values and other data are present in the TKV that are suitable to create or image competences or competence profiles. The texts and data of the DA, DX on the storage unit MA can be analyzed and filtered by means of the data of the TKV, so that the data is reduced in such a way that data of the competence data table TKD can be generated on this basis.

FIG. 6 symbolically shows the result of a competence data compilation in the form of a competence function resulting from the data DX pertaining to a search for employees. Such a compilation is also called a search function. The competence name, a bar length and a monetary value pertaining to the competence are indicated. An alternative occupation name (mechanical engineer, P.E., or production engineer, P.E.) is indicated for the competence name in the first row position of the search profile. The “driving license” synonym for “driver's license” is shown in the fourth row position. The window G in the lower part shows the formula M=T*H as is known in humatics science as a complement to the data of a search function.

FIG. 7 symbolically shows the alternating search between competence profiles that are present on electronic data processing storage systems I EDVI and search profiles that are present on electronic data processing storage systems K EDVK. Private users PBN as well as commercial users KBN can access the data of the EDVI or of the EDVK, for example, by means of a browser. This is where search algorithms can be started that use the data of a competence function to search through the data of the EDKV or that use the data of a search function to search through the data of the EDVI. In the former case, a private user finds search profiles being offered that fit his/her competence profile. In the latter case, companies find private users that have the sought-after competences.

### INDUSTRIAL APPLICABILITY

The methods and devices have industrial applicability for users of competence functions since screen displays, screen contents and screen layouts, for instance, job searches, are all available to users of competence functions (competence profiles) depending on the occurrence of certain types of data in databases and, by means of the methods and devices, such screen displays, screen contents and screen layouts of job searches can be generated in the form of competence functions (competence profiles) depending on the occurrence of certain types of data in databases.

1. A method for employing designations of competences, occupations, knowledge and skills of the kind often found in the data pools of all kinds of databases, in order to employ editors to compile data for competence functions, characterized in that
whereby a list proposal LV for the selection of data sources for competence data DQ is displayed to a user in a first editor image EB-A;
whereby a user can electronically select at least one data source DQ A;
and the DQ A is listed in another editor image EB-B with its data contents DI;
whereby the DI contains at least one competence name;
whereby the DI is to be taken over in the bar chart EB-C of a competence function KF by means of a mouse click;
in that this data is augmented by additional dynamic data of competence functions for purposes of providing a visual display;
whereby this dynamic data is present on servers and is continuously changed there through the use of competence functions by additional users;
whereby the users change the dynamic data through their use via the Internet.

2. The method according to claim 1, characterized in that entire groups of DI are transferred from the DQ of the EB-A to the EB-C.

3. The method according to claim 1, characterized in that
whereby data contents DI pertaining to competences are entered in an editor window EB-B by a user at least with one competence name and description;
whereby this DI is transferred to databases in such a way that
it is available in an editor window EB-A so as to be transferred to competence functions according to EB-C.

4. The method according to claim 1, characterized in that
1) in that data pertaining to a competence name is displayed in the editor window EB-C in another window G,
2) whereby this data is obtained from the data that is present on servers pertaining to the competence data in databases.

5. A method for the interaction of technical devices in order to perform an automated compilation of competence profiles, characterized in that
website addresses URI X are present in electronically stored form in a URI list in a technical system,
whereby a computer or server SA with an Internet connection uses the URI list in order to establish a connection to the computers URI-X,
whereby data DX is present on the computers URI-X and serves to search for personnel,
whereby the SA uses the establishment of a connection to the computer URI-X in order to transmit the data DX via the Internet to a storage unit MA in an electronic data processing system,
whereby another computer CG has programs and access possibilities on the MA for purposes of evaluating the data DX from the MA in such a way
as to yield a table for competence data DX,
so that the data of the DX can be displayed in the graphic form of a competence function.

6. The method according to claim 5, characterized in that
1) in addition to the TKD, the original data DX is stored in a storage unit in such a way that
2) it is available either in the reduced form of the table pertaining to competence data DX or in the original form DX for electronic systems when the TKD is retrieved.

7. The method according to claim 5, characterized in that
data from a competence data template table TKV is used by the CG to generate the data of the TKD,
whereby unambiguous identifiers ID are associated with competence names in the TKV,
whereby software routines in the CG check whether competence names or identifiers ID are contained in the data of the DA,
whereby the competence names found are associated with an identifier ID or the identifier IDs found are associated with a competence name and transferred to the TKD,
by means of which the TKD can be augmented with additional data using the ID or the associated competence names from the table TKV.

8. The method according to claim 5, characterized in that
1) the data from the competence data template table TKV also contains data resulting from statistical calculations or from methods or calculations of humatics,
2) whereby it is also possible to employ data from other sources that is present on local or decentralized electronic data processing systems.

9. The method according to claim 5, characterized in that data such as a company address, a contact person or a reference number is additionally entered into the TKD.

10. The method employing a technical device CG such as a technical electronic data processing system, according to claim 5, characterized in that
1) several synonymous competence names are present for one identifier ID of the TKV,
2) with which the CG transfers these synonymous competence names to the TKD.

11. The method employing a technical device CG such as a technical electronic data processing system, according to claim 5, characterized in that
several alternative competence names appear in the data DX,
whereby these alternative competence names are associated with different identifiers,
as a result of which alternative competence names with different IDs for one and the same table position are made available to the TKD by the CG.

12. The method employing a technical device CG such as a technical electronic data processing system, according to claim 5, characterized in that
private browser users PBN such as commercial browser users KBN access data in electronic data processing storage systems I EDVI as well as electronic data processing storage systems K EDVK via the Internet,
whereby competence functions of private or individual users are present in the EDVI,
whereby search functions of commercial users are present in the EDVK,
so that the data of the individual competence functions in the EDVI are used to find certain search functions in the EDVK,
or the data of the search functions in the EDVK is used to find certain competence functions in the EVDI.

13. The method employing a technical device CG such as a technical electronic data processing system, according to claim 5, characterized in that
via the Internet, the computer SA randomly generates addresses URI X according to an automatic algorithm,
whereby the systems, computers and storage units found with these addresses via the Internet are queried and checked for data of the type that is present in the TKV list,
so that a TKD is drawn up without a known URI list being prescribed.

14. A device for the automated compilation of competence profiles like the technical device CG, especially the technical electronic data processing system, characterized in that
website addresses URI X are present in electronically stored form in a URI list on a technical system,
whereby a computer or server SA with an Internet connection uses the URI list in order to establish a connection to the computers URI X,
whereby data DX is present on the computers URI X and it serves to search for employees,
whereby the SA uses its connection to the computer URI X in order to transmit the data DX via the Internet to a storage unit MA in an electronic data processing system,
whereby another computer CG has programs and access possibilities on the MA for purposes of evaluating the data DX from the MA in such a way
that a table for competence data DX is created on this basis,
so that the data of the DX can be displayed in the graphic form of a competence function.

15. The device according to claim 14, characterized in that
the data from a competence data template table TKV is used by the CG to generate the data of the TKD,
whereby unambiguous identifiers ID are associated with competence names in the TKV,
whereby software routines in the CG check whether competence names or identifiers ID are contained in the data of the DA,
whereby the found competence names are associated with an identifier ID or whether the found identifier IDs are associated with a competence name and transferred to the TKD,
by means of which the TKD can be augmented with additional data using the ID or the associated competence name from the table TKV.
